(19) United States
(12) Patent Application Publication
(10) Pub. No.: US 2021/0223501 A1
(43) Pub. Date: Jul. 22, 2021

(54) ELECTRIC-ZOOMING LASER MODULE

(71) Applicant: LECC TECHNOLOGY CO., LTD., Taoyuan CIty (TW)

(72) Inventor: HSIN-CHIH TUNG, KINMEN COUNTY (TW)

(21) Appl. No.: 16/923,188

(22) Filed: Jul. 8, 2020

(30) Foreign Application Priority Data
Jan. 20, 2020 (TW) 109200859

(51) Int. Cl. G02B 7/04; G02B 19/00; G01M 11/02

(52) U.S. Cl. CPC G02B 7/04; G01M 11/0228; G02B 19/0052; G02B 19/0009

(57) ABSTRACT

An electric-zooming laser module includes a laser unit, a focusing lens, and an electric device. The laser unit is configured to emit laser light. The focusing lens corresponds in position to the laser unit, and the focusing lens is configured to converge the laser light emitted from the laser unit to outwardly output the laser light. The electric device is connected to the focusing lens, and the electric device is configured to be actuated by changing a current, a voltage, or a polarity of the electric device. The electric device is configured to drive and move the focusing lens in a straight line toward or away from the laser unit to adjust a focal length of the focusing lens. Accordingly, the focusing lens is arranged on a pre-determined location and completes focusing a focal point of the focusing lens.

### CROSS-REFERENCE TO RELATED PATENT APPLICATION

This application claims the benefits of priority to Taiwan Patent Application No. 109200859, filed on Jan. 20, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a laser module, and more particularly to an electric-zooming laser module.

### BACKGROUND OF THE DISCLOSURE

Most conventional laser modules include a laser unit and a focusing lens, and the laser unit is configured to be electrically connected to a circuit board that is configured to actuate the laser unit to emit laser light. The focusing lens is disposed in front of the laser unit, and a central axis of the focusing lens and a central axis of the laser unit are coaxially aligned. The focusing lens is configured to converge the laser light emitted from the laser unit so as to outwardly output the laser light. However, a focal length of the focusing lens of the conventional laser modules can only be adjusted by mechanical means. Accordingly, the conventional laser module is inconvenient to operate, and users may have difficulties in adjusting the focal length of the focusing lens once the laser module has been shipped.

### SUMMARY OF THE DISCLOSURE

In response to the above-referenced technical inadequacies, the present disclosure provides an electric-zooming laser module that is configured to adjust a focal length of a focusing lens by electric means. The laser module is convenient for users to operate, and the focal length of the focusing lens can be adjusted as needed.

In one aspect, the present disclosure provides an electric-zooming laser module, and the laser module includes a laser unit, a focusing lens, and an electric device. The laser unit is configured to emit laser light. The focusing lens corresponds in position to the laser unit, in which the focusing lens is configured to converge the laser light emitted from the laser unit so as to outwardly output the laser light. The electric device is connected to the focusing lens, in which the electric device is configured to drive and move the focusing lens in a straight line toward or away from the laser unit so as to adjust a focal length of the focusing lens.

In certain embodiments of the present disclosure, the laser module further includes a base, and the laser unit and the electric device are fixedly disposed on the base.

In certain embodiments of the present disclosure, the electric device is configured to be actuated by changing a current, a voltage, or a polarity of the electric device.

In certain embodiments of the present disclosure, the electric device is a linear motor.

In certain embodiments of the present disclosure, the electric device is a voice coil motor.

In certain embodiments of the present disclosure, the laser module further includes a control unit electrically connected to the electric device.

In certain embodiments of the present disclosure, the laser module further includes a detecting device spaced apart from the focusing lens, in which when the laser light emitted from the laser unit is converged through the focusing lens, the laser light is outputted from the focusing lens and travels onto the detecting device for detection of the focal length of the focusing lens.

In another aspect, the present disclosure provides an electric-zooming laser module, and the laser module includes a base, a laser unit, a focusing lens, a control unit, and an electric device. The laser unit is disposed on the base, in which the laser unit is configured to emit laser light. The focusing lens corresponds in position to the laser unit, in which the focusing lens is configured to converge the laser light emitted from the laser unit so as to outwardly output the laser light. The electric device is disposed on the base, in which the electric device is a voice coil motor and is connected to the focusing lens. The electric device is electrically connected to the control unit that is configured to actuate the electric device to drive the focusing lens in a straight line toward or away from the laser unit so as to adjust a focal length of the focusing lens.

In conclusion, the laser module of the present disclosure includes the laser unit, the focusing lens, and the electric device. The electric device is connected to the focusing lens, and the electric device is configured to drive and move the focusing lens in the straight line toward or away from the laser unit so as to adjust the focal length of the focusing lens. Accordingly, the laser module of the present disclosure is configured to adjust the focal length of the focusing lens by electric means. The laser module is convenient to operate, and users can adjust (or slightly adjust) the focal length of the focusing lens as needed once the laser module has been shipped.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of an electric-zooming laser module according to a first embodiment of the present disclosure.

FIG. 2 is a schematic view of a zooming action of the laser module according to the first embodiment of the present disclosure.

FIG. 3 is another schematic view of the zooming action of the laser module according to the first embodiment of the present disclosure.

FIG. 4 is a schematic view of the laser module according to a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

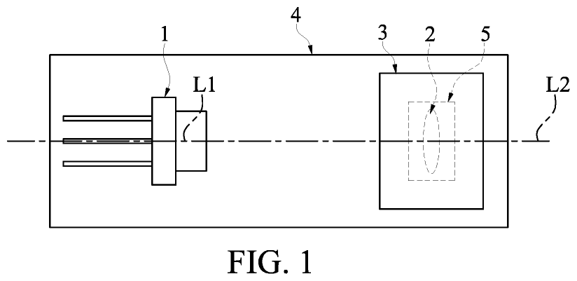

Referring to FIG. 1, a first embodiment of the present disclosure provides an electric-zooming laser module, and the laser module includes a laser unit 1, a focusing lens 2, and an electric device 3. The laser unit 1 is a laser light source including laser diodes, and the laser unit 1 is electrically connected to a circuit unit (the circuit unit is not shown in FIG. 1) so that the laser unit 1 can be actuated by the circuit unit to emit laser light.

The focusing lens 2 corresponds in position to the laser unit 1, and the focusing lens 2 is disposed in front of the laser unit 1. The focusing lens 2 and the laser unit 1 are located along the same straight direction, that is, a central axis L2 of the focusing lens 2 and a central axis L1 of the laser unit 1 are the same straight line. The focusing lens 2 is configured to converge the laser light emitted from the laser unit 1 so as to outwardly output the laser light. The laser module further includes a lens holder 5, and the focusing lens 2 is disposed inside of the lens holder 5. The lens holder 5 is a hollow body having two opening ends that allows the laser light emitted from the laser unit 1 to pass through the lens holder 5 from one opening end to the other opening end of the lens holder 5, and when the laser light passes through the focusing lens 2 disposed inside of the lens holder 5, the focusing lens 2 converges the laser light emitted from the laser unit 1 so as to outwardly output the laser light. The structure of the laser unit 1 and the focusing lens 2 are well known in the art, and will not be reiterated herein. However, the present disclosure is not limited thereto.

In the present embodiment, the laser module further includes a base 4. The laser unit 1 is a fixed element, and the focusing lens 2 is a moving element. The laser unit 1 is fixedly disposed on the base 4 and the focusing lens 2 is movably disposed on the base 4. The focusing lens 2 is configured to move toward or away from the laser unit 1 so as to adjust a focal length of the focusing lens 2.

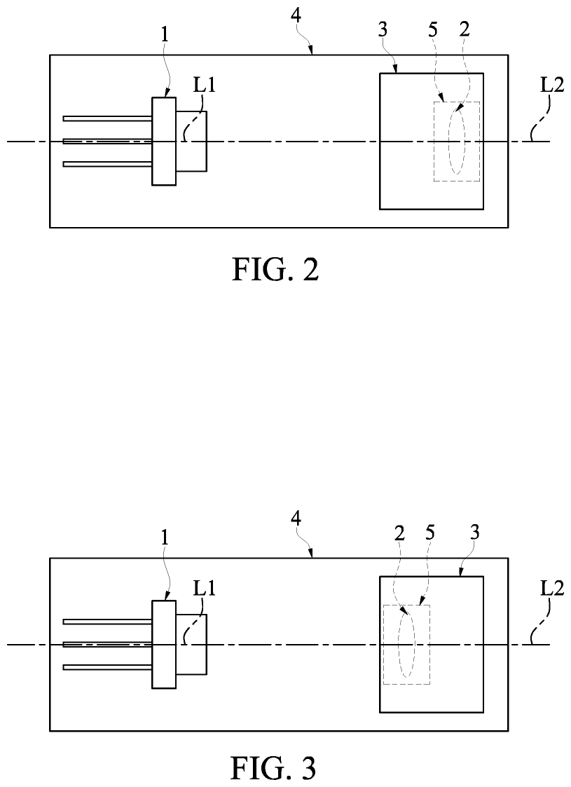

The focusing lens 2 is connected to the electric device 3. In the present embodiment, the focusing lens 2 is disposed inside of the lens holder 5, and the focusing lens 2 is connected to the electric device 3 through the lens holder 5. The electric device 3 can also be disposed on the base 4 so that the laser unit 1 and the electric device 3 are disposed on the base 4, that is, the laser unit 1 and the electric device 3 are fixedly disposed on the base 4 so as to form a modular design. The electric device 3 is actuated by electricity. Specifically, the electric device 3 is configured to be actuated by changing a current, a voltage, or a polarity of the electric device 3 so as to drive and straightly move the focusing lens 2 (as shown in FIG. 2 and FIG. 3). Accordingly, the focusing lens 2 is arranged on a pre-determined location and completes a function of focusing a focal point of the focusing lens 2. The focusing lens 2 preferably travels with a distance of less than 5 millimeters, but it is not limited thereto.

The structure and the module of the electric device 3 are not limited thereto. The electric device 3 can be a device such as a linear motor or a solenoid valve. In the present embodiment, the electric device 3 is the linear motor, for example, the electric device 3 can be a voice coil motor that has advantages of having a smaller size and taking up less space. The electric device 3 is configured to be actuated by changing a DC current of inner coils of the voice coil motor so as to drive and move the focusing lens 2 in a straight line toward or away from the laser unit 1. For example, when a greater DC current is provided to the voice coil motor, the electric device 3 drives and straightly moves the focusing lens 2 toward the laser unit 1, and when a less DC current is provided to the voice coil motor, the electric device 3 drives and straightly moves the focusing lens 2 away from the laser unit 1. Accordingly, the focusing lens 2 is arranged on the pre-determined location and completes a function of focusing the focal point of the focusing lens 2.

In another embodiment of the present disclosure, the electric device 3 is configured to be actuated by changing the polarity of the electric device 3. For example, when the DC current is provided to a positive polarity of the electric device 3, and the electric device 3 drives and straightly moves the focusing lens 2 toward the laser unit 1. When the DC current is provided to a negative polarity of the electric device 3, the electric device 3 drives and straightly moves the focusing lens 2 away from the laser unit 1. When the greater DC current is provided to the electric device 3, the electric device 3 moves the focusing lens 2 by a greater distance, and when the less DC current is provided to the electric device 3, the electric device 3 moves the focusing lens 2 by a less distance. Accordingly, the electric device 3 can easily tweak the focal point of the focusing lens 2 by digital control.

In another embodiment of the present disclosure, the focusing lens 2 and the electric device 3 can have a guiding mechanism (not shown in FIG. 1) therebetween. The guiding mechanism is configured to guide the focusing lens 2 to stably move in a straight line. The guiding mechanism includes convex ribs and grooves, but the structure of the guiding mechanism is not limited thereto.

### Second Embodiment

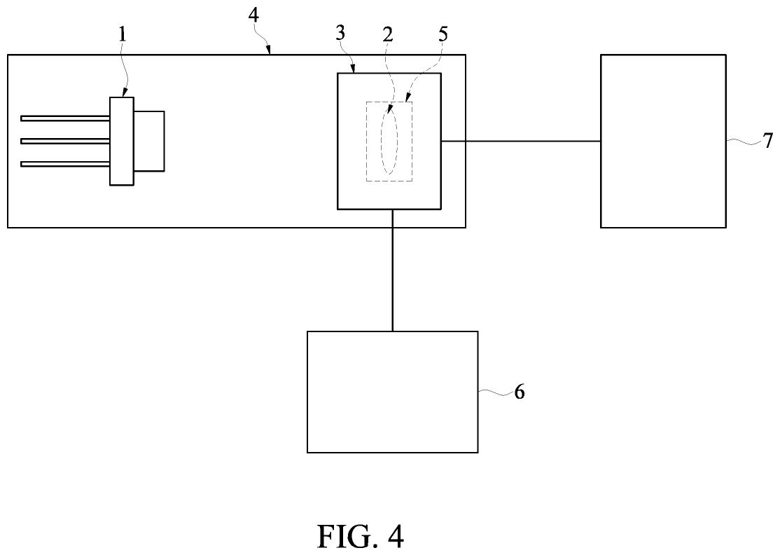

Referring to FIG. 4, the electric device 3 can be connected to a suitable control (or adjustment) interface. In the present embodiment, the electric device 3 is electrically connected to the control unit 6 that is configured to operate through software or hardware. Specifically, the control unit 6 can control the volume of the current provided to the electric device 3 (e.g., a linear motor) so as to actuate the electric device 3 to properly drive the focusing lens 2, and the focusing lens 2 is arranged on the pre-determined location. Furthermore, the laser module may also include a detecting device 7 spaced apart from the focusing lens 2. The focusing lens 2 is arranged between the detecting device 7 and the laser unit 1. The detecting device 7, the focusing lens 2, and the laser unit 1 are located along the same straight line. The focusing lens 2 is configured to converge the laser light emitted from the laser unit 1 so as to outwardly output the laser light on the detecting device 7. When the electric device 3 drives and moves the focusing lens 2 in the straight line toward or away from the laser unit 1 so as to adjust the focal length of the focusing lens 2, the detecting device 7 detects the focal length of the focusing lens 2 until an adjustment of the focal length of the focusing lens 2 is complete, and the electric device 3 will then stop moving the focusing lens 2. Accordingly, the focusing lens 2 is positioned at a fixed position.

In conclusion, the laser module of the present disclosure includes the laser unit, the focusing lens, and the electric device. The electric device is connected to the focusing lens, and the electric device is configured to drive and move the focusing lens in the straight line toward or away from the laser unit so as to adjust a focal length of the focusing lens. Accordingly, the laser module of the present disclosure is configured to adjust the focal length of the focusing lens by electric means. The laser module is convenient to operate, and users can adjust (or fine-tune) the focal length of the focusing lens as needed once the laser module has been shipped.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electric-zooming laser module, comprising:
a laser unit being configured to emit laser light;
a focusing lens corresponding in position to the laser unit, wherein the focusing lens is configured to converge the laser light emitted from the laser unit so as to outwardly output the laser light; and
an electric device connected to the focusing lens, wherein the electric device is configured to drive and move the focusing lens in a straight line toward or away from the laser unit so as to adjust a focal length of the focusing lens.

2. The laser module according to claim 1, further comprising a lens holder, wherein the focusing lens is disposed inside of the lens holder, and the focusing lens is connected to the electric device through the lens holder.

3. The laser module according to claim 1, further comprising a base having the laser unit and the electric device fixedly disposed thereon.

4. The laser module according to claim 1, wherein the electric device is configured to be actuated by changing a current, a voltage, or a polarity of the electric device.

5. The laser module according to claim 1, wherein the electric device is a linear motor.

6. The laser module according to claim 1, wherein the electric device is a voice coil motor.

7. The laser module according to claim 1, further comprising a control unit electrically connected to the electric device, wherein the control unit is configured to actuate the electric device to drive the focusing lens.

8. The laser module according to claim 1, further comprising a detecting device spaced apart from the focusing lens, wherein the focusing lens is arranged between the detecting device and the laser unit, and the detecting device, the focusing lens, and the laser unit are located along the same straight line, and wherein when the laser light emitted from the laser unit is converged through the focusing lens, the laser light is outputted from the focusing lens and travels onto the detecting device for detection of the focal length of the focusing lens.

9. The laser module according to claim 1, wherein the focusing lens and the laser unit are located along the same straight direction.

10. An electric-zooming laser module, comprising:
a base;
a laser unit disposed on the base, wherein the laser unit is configured to emit laser light;
a focusing lens corresponding in position to the laser unit, wherein the focusing lens is configured to converge the laser light emitted from the laser unit so as to outwardly output the laser light;
a control unit; and
an electric device disposed on the base, wherein the electric device is a voice coil motor and is connected to the focusing lens, and wherein the electric device is electrically connected to the control unit that is configured to actuate the electric device to drive the focusing lens in a straight line toward or away from the laser unit so as to adjust a focal length of the focusing lens.
